(19) United States
(12) Patent Application Publication
(10) Pub. No.: US 2010/0128701 A1
(43) Pub. Date: May 27, 2010

(54) BEACON TRANSMISSION FOR PARTICIPATION IN PEER-TO-PEER FORMATION AND DISCOVERY

(75) Inventor: Nagendra Nagaraja, Bangalore Karnatak (IN)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/276,865

(22) Filed: Nov. 24, 2008

(51) Int. Cl. H04W 4/00

(52) U.S. Cl. 370/338

(57) ABSTRACT

Aspects relate to allowing multimodal devices to communicate over multiple bands to take advantage of lower traffic bands. A device can transmit its interface presence information to a base station on an uplink. The base station can broadcast the presence information to other nodes within the vicinity of base station. Based on the received presence information, the device can selectively establish communication in a peer-to-peer configuration. The presence information on the uplink can be sent on a first interface and the communication between the devices in the peer-to-peer configuration can be on a second interface.

### BACKGROUND

I. Field

The following description relates generally to communication networks and more particularly to peer discovery in ad hoc and/or peer-to-peer networks.

II. Background

Wireless communication systems are widely deployed to provide various types of communication. For example, voice, data, video and so forth can be provided through wireless communication systems. A typical wireless communication system, or network, can provide multiple users access to one or more shared resources. For example, a system may use a variety of multiple access techniques such as Frequency Division Multiplexing (FDM), Time Division Multiplexing (TDM), Code Division Multiplexing (CDM), Orthogonal Frequency Division Multiplexing (OFDM), and others.

Wireless communication networks are commonly utilized to communicate information regardless of where a user is located (inside or outside a structure) and whether a user is stationary or moving (e.g., in a vehicle, walking). Generally, wireless communication networks are established through a mobile device communicating with a base station or access point. The access point covers a geographic range or cell and, as the mobile device is operated, the mobile device can be moved in and out of these geographic cells.

A network can also be constructed utilizing solely peer-to-peer devices without utilizing access points or the network can include both access points (infrastructure mode) and peer-to-peer devices. These types of networks are sometimes referred to as ad hoc networks. Ad hoc networks can be self-configuring whereby when a mobile device (or access point) receives communication from another mobile device, the other mobile device is added to the network. As mobile devices leave the area, they are dynamically removed from the network. Thus, the topography of the network can be constantly changing.

Communication in such networks can be limited, in some cases, to exchanges between devices that are within direct wireless transmission range of each other, while in other cases multi-hop forwarded between non-adjacent devices may be supported. Various techniques may be used to maintain connectivity and/or forwarding information as the topology of the network changes (e.g. as devices join, leave, or move). Some networks can also be constructed utilizing a combination of both peer-to-peer as well as base stations, access points, or access routers.

Generally, when peer nodes are to be discovered, each peer sends a peer discovery message in a particular band. The other peer nodes receive this discovery message and can establish a communication with the transmitting peer nodes. However, these systems assume elimination of infrastructure, which can take a long time to deploy.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with providing a peer-to-peer network over an unlicensed band utilizing a Wide Area Network (WAN) base station beacon broadcast to multi-mode Local Area Network/Wide Area Network (LAN/WAN) devices. Presence information related to a Local Area Network/Peer-to-Peer (LAN/P2P) interface can be sent by nodes to a base station on a WWAN uplink channel. The base station broadcasts the LAN/P2P presence information to all nodes within range of the base station. The nodes that receive this information can form a peer-to-peer network with the nodes for which presence information has been received.

An aspect relates to a mobile device that includes a processor that executes computer executable instructions stored on a computer-readable medium. The instructions include transmitting presence information of the mobile device to a base station on an uplink Wide Area Network (WAN) channel. The mobile device presence information indicates if the mobile device supports a Local Area Network/Peer-to-Peer (LAN/P2P) information. The instructions also relate to receiving from the base station over a downlink broadcast channel aggregated presence information of the mobile device and a plurality of peer devices and establishing a peer-to-peer communication with one of the plurality of peer devices over the LAN/P2P based in part on the aggregated presence information.

Another aspect relates to a multimode communications apparatus that includes a memory and a processor. The memory retains instructions related to transmitting presence information to a base station on a uplink Wide Area Network (WAN) channel. The presence information indicates if the communication apparatus supports a Local Area Network/Peer-to-Peer (LAN/P2P) information. The memory also retains instructions related to receiving over a downlink broadcast channel aggregated presence information of the mobile device and a plurality of peer devices and establishing a peer-to-peer communication with one of the plurality of peer devices over the LAN/P2P based in part on the aggregated presence information. The processor is coupled to the memory and is configured to execute the instructions retained in the memory.

Another aspect relates to a communications apparatus that facilitates participation in peer-to-peer formation. Apparatus includes means for transmitting presence information of the communications apparatus to a base station on a uplink Wide Area Network (WAN) channel. The presence information indicates if the communications apparatus supports a Local Area Network/Peer-to-Peer (LAN/P2P). Apparatus also includes means for receiving from the base station over a downlink broadcast channel aggregated presence information of the communications apparatus and a plurality of peer devices. Also included in apparatus is means for establishing a peer-to-peer communication with one of the plurality of peer devices over the LAN/P2P based in part on the aggregated presence information, wherein the communications apparatus is multimodal.

Yet another aspect relates to a computer program product that includes a computer-readable medium. The computer-readable medium includes a first set of codes for causing a computer to convey presence information to a base station on a uplink Wide Area Network (WAN) channel. The presence information indicates if a Local Area Network/Peer-to-Peer (LAN/P2P) information is supported, a configuration of an interface, and a state of the interface. The computer-readable medium also includes a second set of codes for causing the computer to receive from the base station over a downlink broadcast channel aggregated presence information of participating nodes. Also included is a third set of codes for causing the computer to receive a request to locate a final destination node from the plurality of peer nodes and a fourth set of codes for causing the computer to establish a link with the final destination node though a single hop protocol or a multiple hop protocol.

Still another aspect relates to at least one processor configured to enable participation in peer-to-peer formation. The processor includes a first module for conveying presence information to a base station on a uplink Wide Area Network (WAN) channel, the presence information indicates if a Local Area Network/Peer-to-Peer (LAN/P2P) information is supported, a configuration of an interface and a state of the interface. The processor also includes a second module for receiving from the base station over a downlink broadcast channel aggregated presence information of participating nodes. Further, processor includes a third module for receiving a request to locate a final destination node from the plurality of peer nodes and a fourth module for establishing a link with the final destination node though a single hop protocol or a multiple hop protocol.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of the various aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 illustrates a wireless communication system in accordance with various aspects presented herein.

FIG. 2 illustrates a system that facilitates creation of a LAN/P2P network based on information conveyed over a WAN network, according to an aspect.

FIG. 3 illustrates a system that enables peer discovery and peer-to-peer formation according to an aspect.

FIG. 4 illustrates an example wireless WAN/cellular aided peer-to-peer network in accordance with various aspects presented herein.

FIG. 5 illustrates an example mobile device that enables touch-screen activation of a peer-to-peer application, in accordance with an aspect.

FIG. 6 illustrates example channel structures that can be utilized with the aspects disclosed herein.

FIG. 7 illustrates a method for peer discovery and configuration in a peer-to-peer network configuration, according to an aspect.

FIG. 8 illustrates a system that facilitates peer discovery and formation in a peer-to-peer network in accordance with one or more of the disclosed aspects.

FIG. 9 illustrates an example system that facilitates participation in peer-to-peer formation, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a mobile device. A mobile device can also be called, and may contain some or all of the functionality of a system, subscriber unit, subscriber station, mobile station, mobile, wireless terminal, node, device, remote station, remote terminal, access terminal, user terminal, terminal, wireless communication device, wireless communication apparatus, user agent, user device, or user equipment (UE). A mobile device can be a cellular telephone, a cordless telephone, a Session Initiation Protocol (SIP) phone, a smart phone, a wireless local loop (WLL) station, a personal digital assistant (PDA), a laptop, a handheld communication device, a handheld computing device, a satellite radio, a wireless modem card and/or another processing device for communicating over a wireless system. Moreover, various aspects are described herein in connection with a base station. A base station may be utilized for communicating with wireless terminal(s) and can also be called, and may contain some or all of the functionality of, an access point, node, Node B, e-NodeB, e-NB, or some other network entity.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete manner.

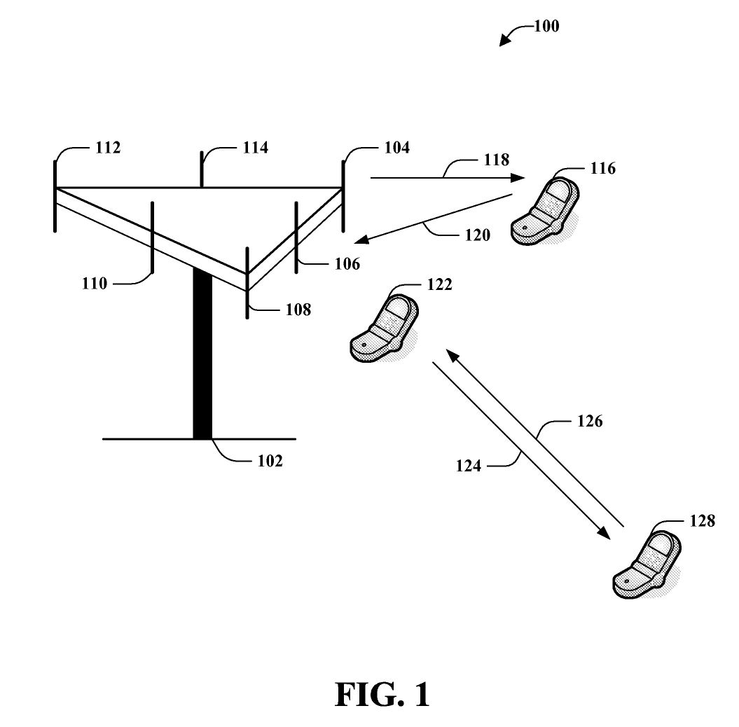

Referring now to FIG. 1, a wireless communication system 100 is illustrated in accordance with various aspects presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a multitude of components associated with signal transmission and reception (e.g., processors, modulators, multiplexers, demodulators, demultiplexers, antennas, etc.), as will be appreciated by one skilled in the art. Additionally, the base station 102 can be a home base station, a Femto base station, and/or the like.

Base station 102 can communicate with one or more mobile devices such as mobile device 116; however, it is to be appreciated that base station 102 can communicate with substantially any number of mobile devices similar to mobile device 116. As depicted, mobile device 116 is in communication with antennas 104 and 106, where antennas 104 and 106 transmit information to mobile device 116 over a forward link 118 and receive information from mobile device 116 over a reverse link 120.

In addition, mobile devices 122 and 128 can be communicating with one another, such as in a peer-to-peer configuration. Moreover, mobile device 122 is in communication with mobile device 128 using similar links 124 and 126. In a frequency division duplex (FDD) system, forward link 118 can utilize a different frequency band than that used by reverse link 120, for example. Further, in a time division duplex (TDD) system, forward link 118 and reverse link 120 can utilize a common frequency band.

In a peer-to-peer ad hoc network, devices within range of each other, such as devices 122 and 128, communicate directly with each other without a base station 102 and/or a wired infrastructure to relay their communication. Additionally, peer devices or nodes can relay traffic. The devices within the network communicating in a peer-to-peer manner can function similar to base stations and relay traffic or communications to other devices, functioning similar to base stations, until the traffic reaches its ultimate destination. The devices can also transmit control channels, which carry information that can be utilized to manage the data transmission between peer nodes.

A communication network can include any number of mobile devices or nodes that are in wireless communication. Each node can be within range of one or more other nodes and can communicate with the other nodes or through utilization of the other nodes, such as in a multi-hop topography (e.g., communications can hop from node to node until reaching a final destination). For example, a sender node may wish to communicate with a receiver node. To enable packet transfer between sender node and receiver node, one or more intermediate nodes can be utilized. It should be understood that any node can be a sender node and/or a receiver node and can perform functions of either sending and/or receiving information at substantially the same time (e.g., can broadcast or communicate information at about the same time as receiving information).

In accordance with the various aspects presented herein, each mobile device can be a multimode device that can support LAN/P2P information. Each device can transmit its presence information to a base station utilizing a first interface. For example, the first interface can be a licensed spectrum, such as a Wide Area Network (WAN). The presence information can include whether or not the transmitting device can support LAN/P2P information. If supported, the presence information can include the configuration of the interface and the state of the interface. The base station can gather the information from the mobile devices within its serving area and broadcast the gathered presence information to the other devices over the first interface (e.g. WAN). This information allows the devices to establish a peer-to-peer network and communicate with each other over a second interface. For example, the second interface can be an unlicensed spectrum, such as a LAN/P2P network. Thus, the nodes are not restricted to a single interface or a licensed spectrum. Further, the disclosed aspects provide a lower cost implementation by creating peer-to-peer networks as disclosed herein.

In accordance with some aspects, the devices can communicate in a single hop configuration and/or a multi-hop configuration. A multi-hop configuration comprises multiple nodes that form a temporary network without the use of a centralized administration or infrastructure. The throughput of a multi-hop network can depend on various parameters, such as the distance between nodes, a transmission power, and environment characteristics (e.g., noise, path loss, fading, and so on).

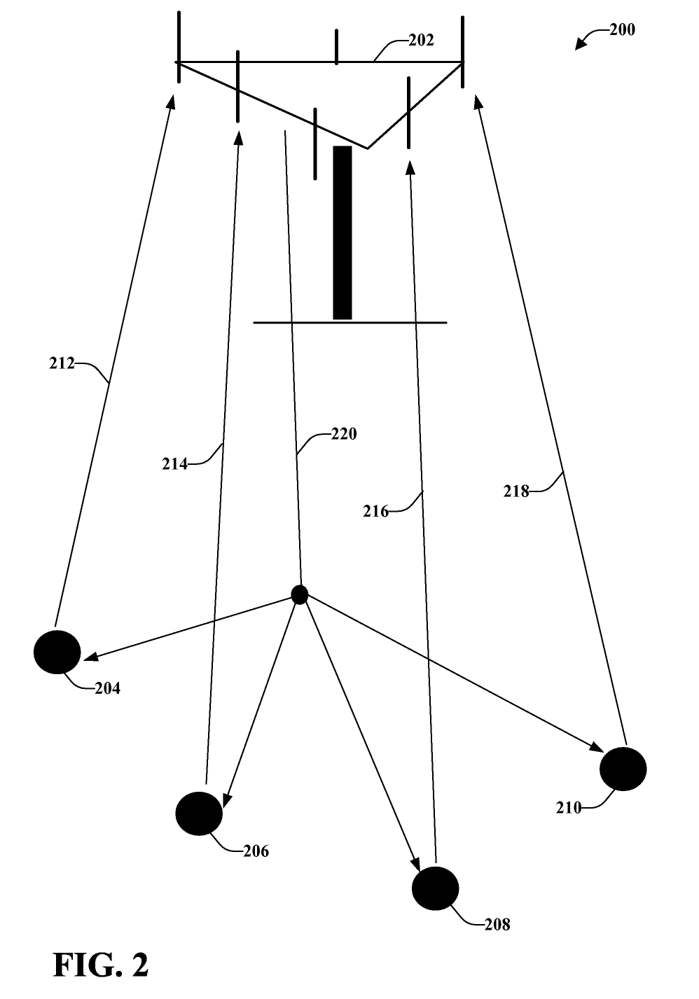

FIG. 2 illustrates a system 200 that facilitates creation of a LAN/P2P network based on information conveyed over a WAN network, according to an aspect. Illustrated are a base station 202 and four nodes 204, 206, 208, and 210. The nodes can be, for example, multimode mobile devices. Each node 204-210 can transmit its presence information on an uplink LAN/P2P, illustrated at 212, 214, 216, and 218. The aggregated presence information is broadcast by base station 202 to all nodes 204-210 on a downlink, illustrated at 220. Based on this broadcast aggregated presence information 220, the nodes 204-210 can selectively form a peer-to-peer network.

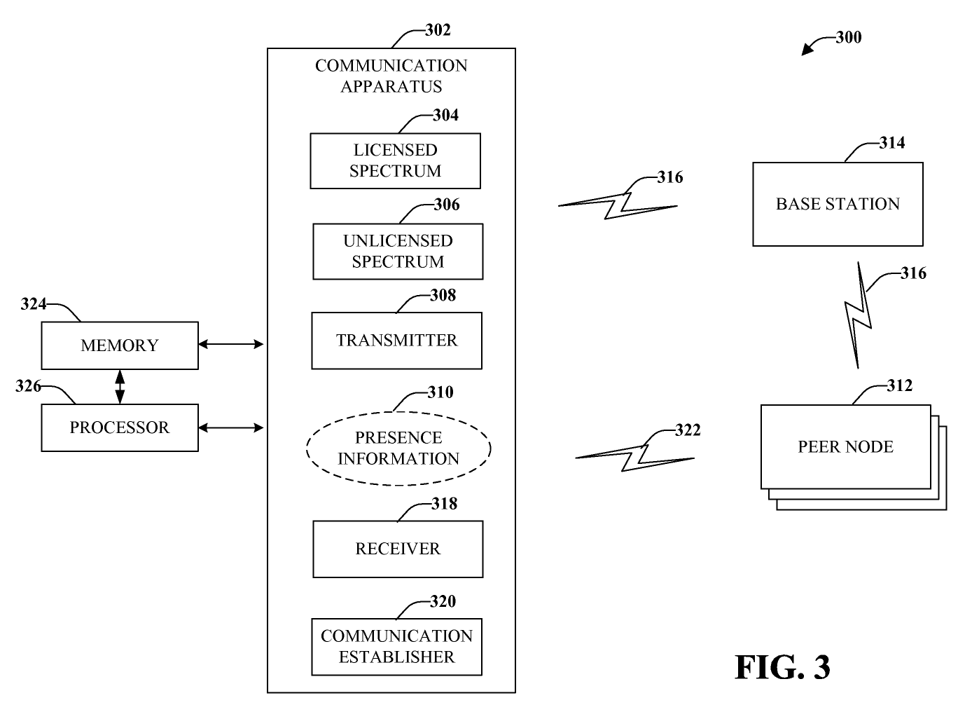

FIG. 3 illustrates a system 300 that enables peer discovery and peer-to-peer formation according to an aspect. System 300 can be utilized by multimode devices (e.g., peers) to create a peer-to-peer network. In accordance with some aspects, a beacon signal design can assist in peer-to-peer formation with lower power transmission. In conventional systems, where peer nodes have to be discovered, each peer sends a peer discovery message in a particular band. These conventional systems generally assume complete elimination of infrastructure, which can take a long time to deploy. The disclosed aspects facilitate peer-to-peer operations in unlicensed bands, which are advantageous in areas or countries (e.g., India) where the unlicensed band is not crowded.

System 300 includes a wireless communications apparatus 302 that is configured with multimode capability, wherein apparatus 302 can support communication over a licensed spectrum 304, over an unlicensed spectrum 306 or over both the licensed spectrum 304 and the unlicensed spectrum 306. In an example, the licensed spectrum 306 can be a Wide Area Network and the unlicensed spectrum 304 can be a LAN/P2P network. The disclosed aspects can provide a more power efficient multimode device than a direct link peer discovery in multimode devices. In accordance with some aspects, the peer-to-peer applications are not standalone peer-to-peer networks.

Periodically or based on other parameters, a transmitter 308 can be configured to convey presence information 310 associated with apparatus 302. The presence information 310 can be transmitted on an uplink WAN channel. The presence information 310 can include an identification of apparatus 302, capabilities of apparatus 302, and other information that can be utilized by peer nodes 312 to communicate with apparatus or through utilization of apparatus 302 (e.g., multi-hop configuration).

The presence information can indicate the capabilities of communication apparatus 302. For example, the presence information can indicate if the multimode apparatus 302 supports LAN/P2P information. If LAN/P2P information is supported, included in the presence information can be the configuration of the interface and a state of the interface (e.g., “ACTIVE”, “IDLE”, “OFF”, “ON”). In accordance with some aspects, the presence information can include location information (e.g., geographic coordinates, GPS information, and so forth).

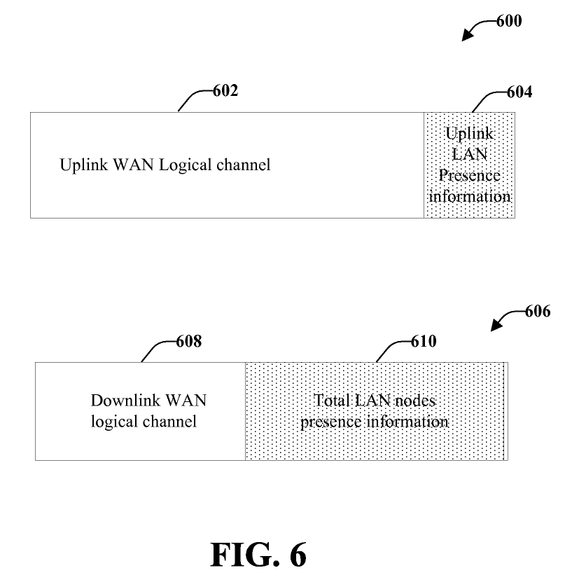

In order to convey the interface presence information, around one-bit of information can be added to an uplink beacon of a Wi-Max/LTE device, which can also support an 802.11n LAN interface. Thus, the power consumption utilized by the disclosed aspects can be minimized for multi-mode devices. Further information related to a channel structure for the presence information will be provided below with reference to FIG. 6.

The presence information 310 can be received by a central node, such as a base station 314. At substantially the same time (or at different times), peer nodes 312 can transmit their presence information to base station 314 over the uplink WAN channel 316 (e.g., the same spectrum utilized by communication apparatus 302). It should be appreciated that the peer nodes 312 can be configured substantially the same as apparatus 302, wherein the peer nodes 312 have multimode capabilities and can utilize the multimode capabilities to facilitate peer-to-peer discovery and network formation as disclosed herein.

Base station 314 can be configured to receive the presence information received from apparatus 302 and/or peer nodes 312 that are within base station's service area. Base station 314 can aggregate the presence information and broadcast the presence information to communication apparatus 302 and peer nodes 312 over a downlink broadcast channel to allow those entities to discover each other. The presence information can be broadcast to apparatus 302 and/or peer nodes 312 over the first spectrum or WAN channel 310. In accordance with some aspects, the information broadcast by the base station 314 can include the location information of each node and each node's presence information. Communication apparatus 302 can include a receiver 318 that is configured to receive the information from base station 314. It should be appreciated that, in accordance with some aspects, transmitter 308 and receiver 318 can be a single component.

The presence information of the peer nodes 312 can be utilized by a communication establisher 320 to construct a peer-to-peer network with one or more peer nodes 312. In accordance with some aspects, the peer-to-peer network can be established over a second spectrum 322, which can be an unlicensed spectrum such as a LAN/P2P network. In such a manner, the unlicensed spectrum, which might be underutilized, can allow nodes 302, 312 to facilitate communication in a peer-to-peer configuration.

In an example, each participating node 302, 312 can utilize the broadcast information to locate a final destination node with which it desires to communicate, which can be either a single hop protocol or a multiple hop protocol to establish the link with the destination node. The final destination node can be selected by a user through a software utility to interface with a mobile device protocol stack. In accordance with some aspects, communication apparatus 302 includes a touch screen to allow a user to interface with the software utility.

In accordance with some aspects, the presence information is downloaded to the peer node(s) 312, which can utilize a function to connect to the desired node (e.g., communication apparatus 302). For example, a function similar to a Wi-Fi Distributed Coordination Function (DCF) protocol or another peer-to-peer protocol can be utilized. In a similar manner, communication apparatus 302 can download the presence information of one or more peer nodes 312 to connect to the peer nodes 312. The presence information can assist in building a multi-hop network since a node can have presence information of other nodes that are outside the range of a peer-to-peer link. Thereby, the nodes can establish a cooperative multi-hop network.

According to various aspects, system 300 can operate similar to a cognitive radio and/or a software defined radio system. For example, a cognitive radio allows a network and/or a node to change reception and/or transmission parameters in order for the network or node to achieve more efficient communication. In such a manner, the network and/or node can mitigate interference with licensed or unlicensed nodes. A software defined radio system includes components that are implemented though software instead of being implemented through hardware.

System 300 can include memory 324 operatively coupled to communication apparatus 302. Memory 324 can be external to communication apparatus 302 or can reside within communication apparatus 302. Memory 324 can store information related to participating in peer-to-peer formation and discovery, and other suitable information related to signals transmitted and received in a communication network. Memory 324 can store protocols associated with peer discovery, taking action to control communication between communication apparatus 302, peer nodes 312 and/or base station 314 such that system 300 can employ stored protocols and/or algorithms to achieve improved communications in a wireless network as described herein.

It should be appreciated that the data store (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to comprise, without being limited to, these and other suitable types of memory.

A processor 326 can be operatively connected to communication apparatus 302 (and/or memory 324) to execute computer executable instructions stored on a computer-readable medium. Processor facilitates analysis of information related to peer-to-peer discovery and formation in a communication network. Processor 326 can be a processor dedicated to analyzing and/or generating information received by communication apparatus 302, a processor that controls one or more components of system 300, and/or a processor that both analyzes and generates information received by communication apparatus 302 and controls one or more components of system 300.

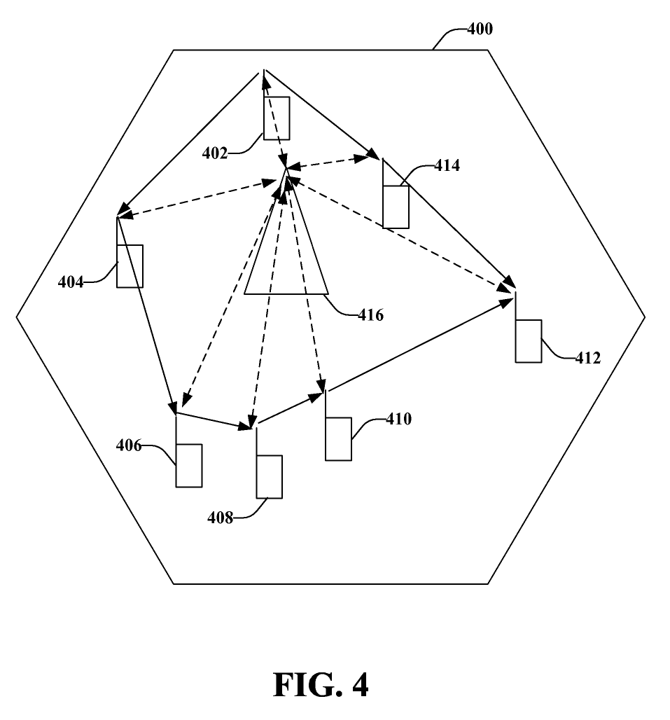

FIG. 4 illustrates an example wireless WAN/cellular aided peer-to-peer network 400 in accordance with various aspects presented herein. Illustrated are peer nodes, labeled node₁ 402, node₂ 404, node₃ 406, node₄ 408, node₅ 410, node₆ 412, and node₇ 414. The nodes 402-414 can be multimode nodes that have capability to communication over a LAN network and/or a WAN network.

The nodes 402-414 can communicate with a centralized base station 416 over an uplink and the base station 416 can communicate with the nodes 402-414 though a downlink, illustrated by the bi-directional dashed lines. In accordance with some aspects, the base station 416 and nodes 402-414 communicate over a WAN channel. Each node 402-414 can communicate its presence information to the base station 416 on the uplink. The presence information can be transmitted periodically by nodes 402-414 or based on other parameters (e.g., detection of peer nodes, detection of a different base station, upon power up, based on a request from base station 416, and so forth).

For example, the nodes 402-414 can have multiple capabilities (e.g. Wi-Fi, OFDM, GSM, CDMA). When a node is in a wireless LAN mode, for example, the node can transmit one bit on the GSM interface (band interface) to notify other devices that its LAN interface is enabled. In accordance with some aspects, the node can also transmits it location (e.g. geographic coordinates, GPS information, and so forth) to the base station 416. The information related to the LAN mode and the location information can be included in the presence information that is transmitted to base station 416 on the uplink. Additionally or alternatively, the presence information can indicate if the node supports LAN/P2P information and, if so, also included is the interface and the state of the interface.

The base station 416 collects all the device presence information and, therefore, knows how many devices are in the LAN network. The base station 416 can convey the aggregated presence information of each node 402-414 to the other nodes over a WAN channel. The presence information can be broadcast periodically to all the nodes 402-414 by the base station 416.

For example, base station 416 can convey the presence of node₁ 402 to the other nodes 404-414. Further, the presence information of node₂ 404 can be broadcast to the other nodes 402 and 406-414, and so forth. The base station 416 can convey this information in a beacon, which can be a single beacon or multiple beacons. For example, in each frame there can be multiple beacons (e.g., three beacons, four beacons, and so forth) transmitted. In such a manner, each node has the presence information of the other nodes. In accordance with some aspects, location information (e.g., GPS information) can be included in the beacon(s).

Based on the presence information of the other nodes, each node can selectively establish communication with one or more other nodes. These nodes can establish communication there between in a peer-to-peer configuration (e.g., single hop topology, multiple-hop topology). In accordance with some aspects, the peer-to-peer configuration allows communication over a second spectrum, such as an unlicensed spectrum.

In an example, the participating nodes (e.g. nodes that support LAN/P2P information) can use the aggregated presence information from base station 416 to locate a final destination node with which to communicate. Thus, a link can be established to the destination node in a single hop protocol or a multiple hop protocol.

In accordance with some aspects, a complete infrastructure is not removed (e.g., base stations are utilized). The disclosed aspects can enable a shorter range peer-to-peer application utilizing multimodal devices. If a large number (or all) devices in the network are multi-mode, an ad-hoc LAN interface can be scalable. However, the scalability might be limited by the capabilities of the WAN interface.

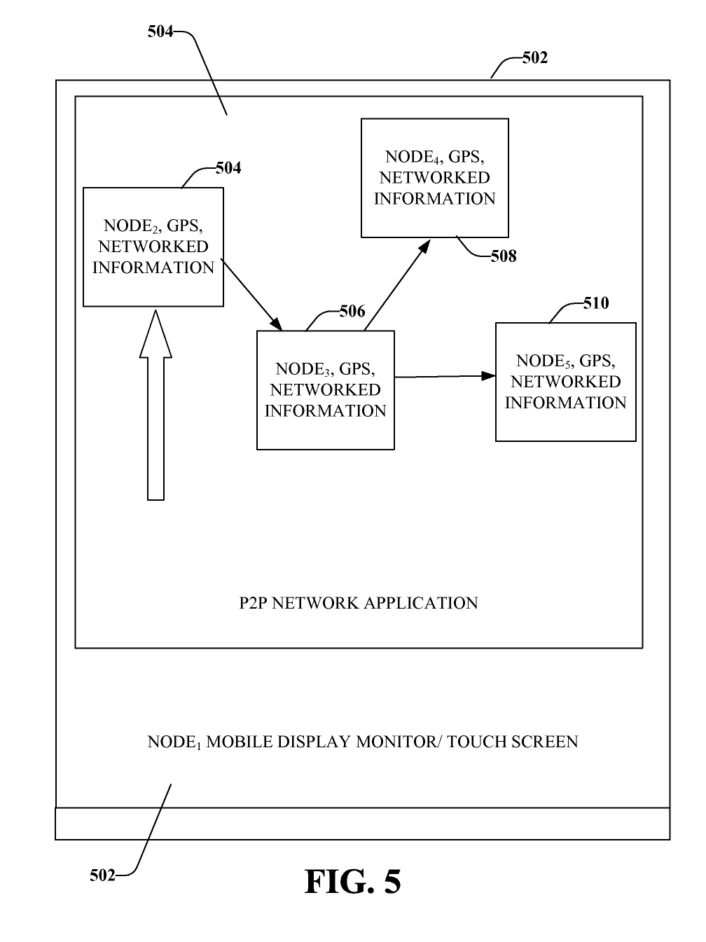

FIG. 5 illustrates an example mobile device 500 that enables touch-screen activation of a peer-to-peer application, in accordance with an aspect. The mobile device 500 can include a mobile display monitor 502, which can be a touch screen in accordance with some aspects. A peer-to-peer network application 504 can be presented to the user on a screen associated with mobile device 500. For example, the peer information can be displayed on the screen with the assistance of the cellular network.

The mobile device 500 can provide a graphical user interface (GUI), a command line interface, a speech interface, Natural Language text interface, and the like. For example, a GUI can be rendered that provides a user with a region or means to load, import, select, read, etc. information related to one or more peer nodes, in accordance with the aspects presented herein. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

As illustrated, a user can be presented with information associated with peer nodes. For example purposes, information associated with four peer nodes, labeled Node₂ 504, Node₃ 506, Node₄ 508, and Node₅ 510, as displayed to the user. It should be appreciated that fewer or more peer nodes can be illustrated, and four are illustrated and described for purposes of simplicity.

In accordance with some aspects, the information associated with each node 504-510 can include personalized information (e.g. John's network). The names associated with each can be a logical name, can indicate that it is a social networking group, and so forth. The base station can periodically transmit presence information such that the information is periodically refreshed (e.g., nodes are removed, nodes are added, and so on).

Mobile device 500 and each node 504-510 can transmit its respective presence information to a base station. The presence information can include information associated with interfaces that the mobile device 500 utilizes. In accordance with some aspects, the presence information can include GPS information. The presence information can be transmitted periodically, continuously, or based on other factors (e.g. a request from base station for the information, a manual request from a user when a new area is entered, upon power up, and so forth).

The base station can broadcast the presence information of the nodes periodically (or based on other intervals). When the feature is enabled on mobile device 500, the information related to the other nodes 504-510 is displayed on a screen of mobile device (or conveyed through the user in another manner). In accordance with some aspects, the resolution of the display can be varied (e.g., “zoom in”, “zoom out”) such that network information can be displayed, the number of networks available, how many groups are available, and so forth.

When the user of mobile device 500 desires to communication with a peer (e.g., one or more of nodes 504-510) displayed on the screen, the user can enable the LAN connection by selecting the desired peer. For example, the user can touch the screen to indicate selection of the touched peer node. In another example, the user can enable the connection though other means, such as verbal commands, or selecting the desired peer node though interaction with a keypad, and so forth.

In accordance with some aspects, the user of mobile device 500 can join a multi-hop network by perceiving the network information and the end node that should be joined. Thus, mobile device 500 allows a user join a peer-to-peer network and/or access a distal user by knowing the network information displayed on the screen, as illustrated for each node 504-510. A user can interact with a different user at a far end by knowing the connectivity information and joining at the best highlighted route. The peer-to-peer application 504 can also highlight the best route possible to join an intended node 504-510.

In an example, a user might utilize mobile device 500 to converse with other in social network (e.g. a chat group). The user can select a single node (e.g., Node₄ 508) to connect to a single user. Similarly, when a user selects a particular network the mobile device 500 can directly connect to the network through various protocols (e.g., Wi-Fi, LAN, peer-to-peer, and so forth). After connecting the network, the user can communicate to other users through respective nodes associated with those users. When a user no longer desires to be connected to another node and/or network, the user can selectively deactivate the connection.

In view of the exemplary systems shown and described above, methodologies that may be implemented in accordance with the disclosed subject matter, will be better appreciated with reference to the following flow charts. While, for purposes of simplicity of explanation, the methodologies are shown and described as a series of blocks, it is to be understood and appreciated that the disclosed aspects are not limited by the number or order of blocks, as some blocks may occur in different orders and/or at substantially the same time with other blocks from what is depicted and described herein. Moreover, not all illustrated blocks may be required to implement the methodologies described herein. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 6 illustrates example channel structures that can be utilized with the aspects disclosed herein. Illustrated at 600 is a channel structure that can be utilized by the nodes to transmit the presence information to the base station. The channel structure 600 includes an uplink WAN logical channel 602 and Uplink LAN Presence information 604. Thus, a first interface (WAN) is utilized to convey information related to a second interface (LAN).

Illustrated at 606 is a channel structure that can be utilized by the base station to transmit the aggregated presence information. The channel structure 606 includes a Downlink WAN logical channel 608 and the aggregated LAN nodes presence information 610. The LAN nodes presence information is broadcast to all nodes. In accordance with some aspects, the presence information 610 includes location information and LAN/P2P interface state (e.g., “ACTIVE”, “IDLE”, “OFF”, “ON”).

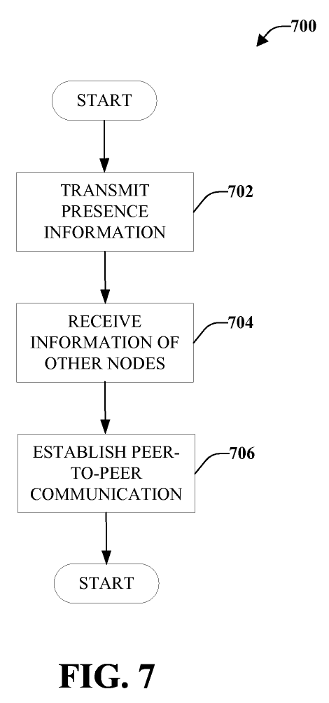

FIG. 7 illustrates a method 700 for peer discovery and configuration in a peer-to-peer network, according to an aspect. Method 700 can be utilized as a service in an unlicensed band. In this unlicensed band, the responsibility of the service provider is to provide channel information or presence information through a broadcast signal. Data traffic can be in an unlicensed band through a wireless peer-to-peer network. A base station can operate as a LAN access point that only provides the presence information, which can enable peer-to-peer communication in the unlicensed band.

Method 700 starts, at 702, when presence information is sent to a base station. The presence information can be sent by a node that is on both a Local Area Network (LAN) network and a Wide Area Network (WAN) network (e.g., multimode device). The presence information can be sent through a WAN physical channel to a WAN/Cellular Base Station. In accordance with some aspects, the presence information can include a mobile node configuration, a best air interface, or combinations thereof. In accordance with some aspects, the presence information can be included in one or more bits of information that can be added to an uplink beacon.

The presence information can indicate whether the multimode device supports LAN/P2P information. If the LAN/P2P information is supported, the presence information can also include a configuration of the interface and the state of the interface (e.g., “ACTIVE”, “IDLE”, “OFF”, “ON”). Additionally, the presence information can include location information.

The base station gathers or aggregates the presence information from all participating devices (e.g., cellular/WAN devices in its range) and broadcasts the collected presence information, at 704, to the peer devices over a downlink broadcast channel. The information broadcast by the base station is utilized by the nodes to learn the presence of other nodes. Based on the presence information, a device can connect to any other device through a single-hop network and/or a multi-hop network.

Based on this information, the user can indicate which, if any, nodes and/or networks with which to connect. Based on this user indication, peer-to-peer communication can be established, at 706, with the one or more peer devices over a second spectrum based on the presence information of the one or more peer devices.

For example, a participating node receives the presence information of other nodes and utilizes this information to locate a final destination node with which a user desires to communicate (based on a user request for establishment of the communication link). A network can be established to facilitate the communication with the final destination link, which can be a single-hop configuration or a multiple hop configuration. In accordance with some aspects, the network establishment can utilize Wi-Fi DCF or another peer-to-peer protocol.

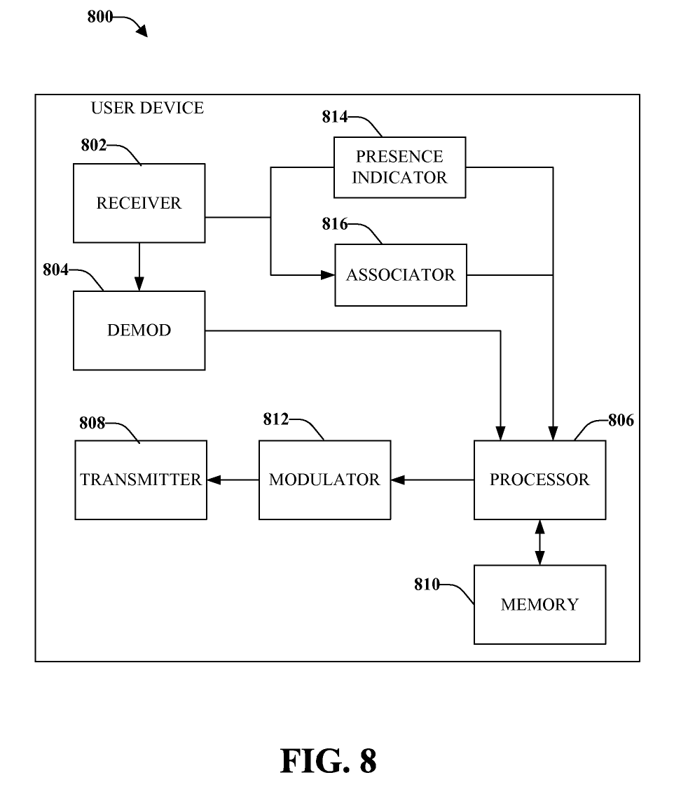

With reference now to FIG. 8, illustrated is a system 800 that facilitates peer discovery and formation in a peer-to-peer network in accordance with one or more of the disclosed aspects. System 800 can reside in a user device. System 800 comprises a receiver 802 that can receive a signal from, for example, a receiver antenna. The receiver 802 can perform typical actions thereon, such as filtering, amplifying, downconverting, etc. the received signal. The receiver 802 can also digitize the conditioned signal to obtain samples. A demodulator 804 can obtain received symbols for each symbol period, as well as provide received symbols to a processor 806.

Processor 806 can be a processor dedicated to analyzing information received by receiver component 802 and/or generating information for transmission by a transmitter 808. In addition or alternatively, processor 806 can control one or more components of user device 800, analyze information received by receiver 802, generate information for transmission by transmitter 808, and/or control one or more components of user device 800. Processor 806 may include a controller component capable of coordinating communications with additional user devices.

User device 800 can additionally comprise memory 808 operatively coupled to processor 806 and that can store information related to coordinating communications and any other suitable information. Memory 810 can additionally store protocols associated with peer discovery and formation. User device 800 can further comprise a symbol modulator 812 and a transmitter 808 that transmits the modulated signal.

Receiver 802 is further operatively coupled to a presence indicator 814 that can be configured to convey presence information related to user device 800. The presence information can be included in an uplink signal transmitted to a base station, such as an uplink WAN channel. The presence information can include whether LAN/P2P is supported. Also coupled to receiver is a peer-to-peer associator 816 that is configured to selectively establish a communication with one or more peer nodes. The communication can be established based upon a user request for the communication to be established with a final destination node.

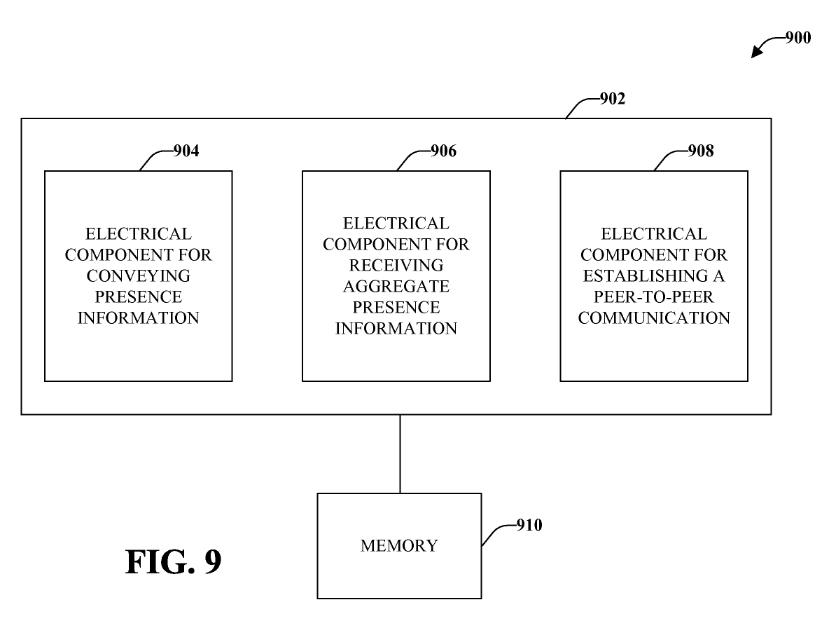

With reference to FIG. 9, illustrated is an example system 900 that facilitates participation in peer-to-peer formation, according to an aspect. System 900 can reside at least partially within a mobile device, which can be a multimode device. It is to be appreciated that system 900 is represented as including functional blocks, which may be functional blocks that represent functions implemented by a processor, software, or combination thereof (e.g., firmware).

System 900 includes a logical grouping 902 of electrical components that can act separately or in conjunction. System 900 includes a logical grouping 902 of electrical components that can act separately or in conjunction. Logical grouping 902 can include an electrical component 904 for transmitting presence information to a base station on a uplink Wide Area Network (WAN) channel. The presence information can indicate if Local Area Network/Peer-to-Peer (LAN/P2P) is supported. In accordance with some aspects, the presence information further indicates a configuration of an interface and a state of the interface. Additionally or alternatively, the presence information can contain location information.

Also included in logical grouping 902 is an electrical component 906 for receiving from the base station over a downlink broadcast channel aggregated presence information of nodes participating in a peer-to-peer network. Further, logical grouping includes an electrical component 908 for establishing a peer-to-peer communication with one of the plurality of peer nodes over the LAN/P2P based in part on the aggregated presence information. The peer-to-peer communication with the one or more peer nodes is in a single-hop configuration or a multiple-hop configuration.

In accordance with some aspects, logical grouping 902 includes an electrical component for receiving a request to locate a final destination node from the plurality of peer nodes and an electrical component for establishing a link with the final destination node though a single hop protocol or a multiple hop protocol. The link can be established with a Wi-Fi Distributed Coordination Function (DCF) protocol. According to some aspects, the request to locate the final destination node is received though a software utility that interfaces with a protocol stack. The software utility can be a touch screen.

Additionally, system 900 can include a memory 910 that retains instructions for executing functions associated with electrical components 904, 906, and 908 or other components. While shown as being external to memory 910, it is to be understood that one or more of electrical components 904, 906, and 908 may exist within memory 910.

It is to be understood that the aspects described herein may be implemented by hardware, software, firmware or any combination thereof When implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor through various means as is known in the art. Further, at least one processor may include one or more modules operable to perform the functions described herein.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. Further, CDMA2000covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, CDMA2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product may include a computer readable medium having one or more instructions or codes operable to cause a computer to perform the functions described herein.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or aspects, it should be noted that various changes and modifications could be made herein without departing from the scope of the described aspects and/or aspects as defined by the appended claims. Accordingly, the described aspects are intended to embrace all such alterations, modifications and variations that fall within scope of the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A mobile device comprising:
a processor that executes the following computer executable instructions stored on a computer-readable medium:
transmitting presence information of the mobile device to a base station on a uplink Wide Area Network (WAN) channel, the mobile device presence information indicates if the mobile device supports a Local Area Network/Peer-to-Peer (LAN/P2P) information;
receiving from the base station over a downlink broadcast channel aggregated presence information of the mobile device and a plurality of peer devices; and
establishing a peer-to-peer communication with one of the plurality of peer devices over the LAN/P2P based in part on the aggregated presence information.

2. The mobile device of claim 1 is a multimode device.

3. The mobile device of claim 1, wherein the presence information further indicates a configuration of an interface and a state of the interface.

4. The mobile device of claim 1, wherein the presence information contains location information.

5. The mobile device of claim 1, wherein the peer-to-peer communication with the one or more peer devices is in a single-hop configuration or a multiple-hop configuration.

6. The mobile device of claim 1, the processor further executes the following computer executable instructions:
receiving a request to locate a final destination node from the plurality of peer nodes; and
establishing a link with the final destination node though a single hop protocol or a multiple hop protocol.

7. The mobile device of claim 6, wherein the link is established with a Wi-Fi Distributed Coordination Function (DCF) protocol.

8. The mobile device of claim 6, wherein the request to locate the final destination node is received though a software utility that interfaces with a protocol stack.

9. The mobile device of claim 8, wherein the software utility is a touch screen.

10. A multimode communications apparatus, comprising:
a memory that retains instructions related to transmitting presence information to a base station on a uplink Wide Area Network (WAN) channel, the presence information indicates if the communication apparatus supports a Local Area Network/Peer-to-Peer (LAN/P2P) information, receiving over a downlink broadcast channel aggregated presence information of the mobile device and a plurality of peer devices, and establishing a peer-to-peer communication with one of the plurality of peer devices over the LAN/P2P based in part on the aggregated presence information; and
a processor, coupled to the memory, configured to execute the instructions retained in the memory.

11. The multimode communications apparatus of claim 10, wherein the presence information further indicates a configuration of an interface and a state of the interface, location information, or combinations thereof.

12. The multimode communications apparatus of claim 10, the memory further retains instructions related to receiving a request to locate a final destination node from the plurality of peer nodes and establishing a link with the final destination node though a single hop protocol or a multiple hop protocol.

13. The multimode communications apparatus of claim 12, wherein the link is established with a Wi-Fi Distributed Coordination Function (DCF) protocol.

14. The multimode communications apparatus of claim 12, the request to locate the final destination node is received though a software utility that interfaces with a protocol stack.

15. The multimode communications apparatus of claim 14, wherein the software utility is a touch screen.

16. A communications apparatus that facilitates participation in peer-to-peer formation, comprising:
means for transmitting presence information of the communications apparatus to a base station on a uplink Wide Area Network (WAN) channel, the presence information indicates if the communications apparatus supports a Local Area Network/Peer-to-Peer (LAN/P2P);
means for receiving from the base station over a downlink broadcast channel aggregated presence information of the communications apparatus and a plurality of peer devices; and
means for establishing a peer-to-peer communication with one of the plurality of peer devices over the LAN/P2P based in part on the aggregated presence information, wherein the communications apparatus is multimodal.

17. The communications apparatus of claim 16, wherein the presence information further indicates a configuration of an interface and a state of the interface.

18. The communications apparatus of claim 16, further comprising:
means for receiving a request to locate a final destination node from the plurality of peer nodes; and
means for establishing a peer-to-peer link with the final destination node though a single hop protocol or a multiple hop protocol.

19. A computer program product, comprising:
a computer-readable medium comprising:
a first set of codes for causing a computer to convey presence information to a base station on a uplink Wide Area Network (WAN) channel, the presence information indicates if a Local Area Network/Peer-to-Peer (LAN/P2P) information is supported, a configuration of an interface, and a state of the interface;
a second set of codes for causing the computer to receive from the base station over a downlink broadcast channel aggregated presence information of participating nodes; and
a third set of codes for causing the computer to receive a request to locate a final destination node from the plurality of peer nodes; and
a fourth set of codes for causing the computer to establish a link with the final destination node though a single hop protocol or a multiple hop protocol.

20. At least one processor configured to enable participation in peer-to-peer formation, comprising:
a first module for conveying presence information to a base station on a uplink Wide Area Network (WAN) channel, the presence information indicates if a Local Area Network/Peer-to-Peer (LAN/P2P) information is supported, a configuration of an interface and a state of the interface;
a second module for receiving from the base station over a downlink broadcast channel aggregated presence information of participating nodes;
a third module for receiving a request to locate a final destination node from the plurality of peer nodes; and
a fourth module for establishing a link with the final destination node though a single hop protocol or a multiple hop protocol.
